(19) United States
(12) Patent Application Publication
(10) Pub. No.: US 2023/0091974 A1
(43) Pub. Date: Mar. 23, 2023

(54) TECHNIQUES ASSOCIATED WITH MAPPING SYSTEM MEMORY PHYSICAL ADDRESSES TO PROXIMITY DOMAINS

(71) Applicant: Intel Corporation, Santa Clara, CA (US)

(72) Inventors: Ritu GUPTA, Sunnyvale, CA (US); Stephen R. VAN DOREN, Portland, OR (US)

(21) Appl. No.: 17/482,897

(22) Filed: Sep. 23, 2021

(51) Int. Cl. G06F 12/06; G06F 12/0842

(52) U.S. Cl. CPC G06F 12/0646; G06F 12/0842; G06F 2212/1008; G06F 2212/608

(57) ABSTRACT

Examples include techniques associated with mapping system memory physical addresses to proximity domains. Examples include mapping system memory physical addresses for a memory coupled with a multi-die system to proximity domains that include cores of a multi-core processor and the associated level 3 (L3) cache for use by each core included in a respective proximity domain. The mapping is to facilitate cache line ownership of a cache line in an L3 cache by an input/output device or agent located on a separate die from the multi-core processor.

### TECHNICAL FIELD

Examples described herein are generally related to techniques associated with mapping system memory physical addresses to proximity domains in a multi-die computing system.

### BACKGROUND

In some server use cases, increases in a core count for some types of system on chips (SoC) have led to the use of dis-aggregated dies in these types of SoCs. The dis-aggregated dies are coupled or connected together using a high-speed package interface, such as for example, an embedded multi-die interconnect bridge (EMIB). One or more input/output (I/O) agents are often disposed on one die while one or more processor cores are disposed on a separate die. Each individual die has its own cache hierarchy. A memory or a large memory side cache is typically shared across the cache hierarchies associated with each of the dies. Data communications between a processor core on the one die and an I/O agent on the separate die are typically conducted via the memory or the large monolithic memory side cache shared across the cache hierarchies associated with the two different dies. Movement of data from the I/O agent to the processor core often involves multiple data movements across the interconnect fabric and EMIB boundaries. The multiple data movements may result in relatively high data access latencies as well as relatively high interconnect power consumption. In addition, relatively high consumption of both memory bandwidth and die-to-die interconnect (EMIB) bandwidths may occur.

A system resource affinity table (SRAT) may be generated in accordance with the Advanced Configuration and Power Interface (ACPI) specification, Version 6.4, published in January 2021 by the Unified Extensible Firmware Interface Forum (UEFI), herein referred to as the “ACPI specification”. According to the ACPI specification, an SRAT associates the following types of devices with system locality/proximity domains—processors, memory ranges (including those provided by hot-added memory devices) and generic initiators (e.g., heterogeneous processors and accelerator devices, graphic processing units (GPUs) and I/O devices with integrated compute or direct memory access (DMA) engines). SRAT is the place where proximity domains are defined. Defined proximity domains provide a mechanism to associate an object (and its children) to an SRAT-defined proximity domain. Typically, devices in a same proximity domain are tightly coupled.

In an example of a system with four processors coupled with eight memory devices (e.g., eight dual in-line memory modules (DIMMs)), there might be four separate proximity domains (0, 1, 2 and 3). For this example, each proximity domain may include a single processor and two memory devices. An operating system (OS) for this system may decide to run some software or application threads on a processor included in a proximity domain-0. For performance reasons, the OS could choose to allocate memory for those threads from two memory devices inside the proximity domain common to the processor and the memory device, proximity domain-0, rather than from a memory device outside of the processor's proximity domain, e.g., domains 1, 2 or 3.

### BRIEF DESCRIPTION OF THE DRAWINGS

FIG. 1 illustrates an example system.

FIG. 2 illustrates an example memory interleave proximity scheme.

FIG. 3 illustrates an example physical address scheme.

FIG. 4 illustrates example domain mapping information.

FIG. 5 illustrates an example first storage medium.

FIG. 6 illustrates an example first flow.

FIG. 7 illustrates an example process.

FIGS. 8A and 8B illustrate block diagrams of core architectures.

FIG. 9 illustrates an example processor.

FIG. 10 illustrates a first example computer architecture.

FIG. 11 illustrates a second example computer architecture.

FIG. 12 illustrates an example software instruction converter.

### DETAILED DESCRIPTION

As contemplated by this disclosure, an I/O device may be a device included in a proximity domain as defined in an SRAT according to the ACPI specification. In a typical deployment of I/O devices in a system, the I/O devices may be interleaved across a complete system memory address space based on uniform memory access (UMA). UMA interleaving of an I/O device across the complete system memory address space poses a challenge of associating an I/O device with a proximity domain and being able to tightly couple the I/O device with a few core caches (e.g., L3 cache). Tightly coupling of I/O Devices with cores and their associated cache in a same proximity domain is desirable for communication, storage, or packet processing applications where I/O devices typically generate or produce data which is consumed by a given core. Low latency is desired by such types of applications and may require an I/O device to write produced data as close to a consuming core in the core's caching hierarchy as possible. However, UMA interleaving for an I/O device's access to the across the complete system physical memory address space results in interleaving to less proximity domains than are defined in an SRAT for cores, I/O devices, and memory devices. This may result in an I/O device having to first write produced data all the way to system memory rather than directly write to a consuming core's caching hierarchy or writing to a cache that is not in consuming core's caching hierarchy if the system memory address for the produced data is at a memory device included in a different proximity from that of the consuming core. Writing first to system memory or to an incorrect caching hierarchy may add an unacceptable amount of latency for communication, storage, or packet processing applications.

Standard cache coherency protocols, such as for example the MESI protocol, include a modified M cache state, an exclusive E cache state, a shared S cache state, and an invalid I cache state. According to some examples, a placeholder P cache state may be added to the existing MESI protocol to create a MESIP protocol. For these examples, the placeholder P cache state enables an agent associated with one cache hierarchy to obtain ownership of a cache line in a different cache hierarchy.

In some examples, the MESIP protocol concept may be applied to the performance of a write operation by an I/O agent at a I/O domain to a cache line in a compute domain cache hierarchy in a compute domain. An I/O domain typically includes one or more I/O devices, one or more I/O agents, an I/O domain cache hierarchy, and a I/O domain caching agent. A compute domain typically includes one or more cores, a compute domain cache hierarchy, and a compute domain caching agent. The example placeholder P cache state of the MESIP protocol may enable the I/O agent in the I/O domain to write I/O data to a cache line in an L3 cache of the compute domain cache hierarchy. More specifically, as described more below, the I/O agent requests ownership of a cache line in the compute domain cache hierarchy from the compute domain caching agent. In response to the ownership request, the compute domain caching agent places the cache line in the compute domain cache hierarchy in the placeholder P cache state. When the cache line is placed in the placeholder P cache state, the cache line is reserved for the I/O agent to perform a write operation to that cache line. The placeholder P cache state provides temporary ownership of the cache line in the compute domain cache hierarchy to the I/O agent without providing the contents of the cache line to the I/O agent. When the cache line is placed in the placeholder P cache state, the content of the cache line is dirty with respect to memory. Upon receiving ownership of the cache line, the I/O agent transmits I/O data to the compute domain caching agent via the I/O domain caching agent to write to the cache line. Upon completion of the write operation, the cache line is transitioned out of the placeholder P cache state to the modified M cache state.

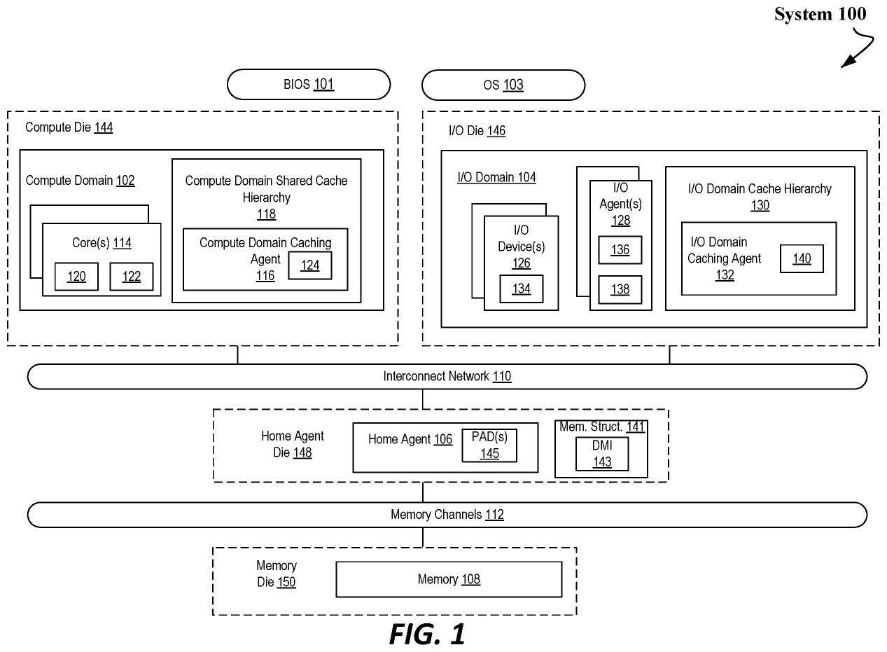

FIG. 1 illustrates an example system 100. System 100 may be at least a portion of, for example, a server computer, a desktop computer, or a laptop computer. In some examples, as shown in FIG. 1, system 100 includes a basic I/O system (BIOS) 101, an operating system (OS) 103, a compute domain 102, an input/output (I/O) domain 104, a home agent 106, and a memory 108. For these examples, compute domain 102, I/O domain 104, and home agent 106 may be communicatively coupled via an interconnect network 110 that includes die-to-die or chip-to-chip interconnects between compute die 144, I/O die 146 and home agent die 148. Home agent 106 may be communicatively coupled to the memory 108 via one or more memory channel(s) 112. Communications within compute domain 102 and within I/O domain 104 may be in accordance with on-die or intra-die communication protocols, such as but not limited to, the Intel® Intra-Die Interconnect (IDI) protocol. Communications between compute domain 102, I/O domain 104, and home agent 106 across or via interconnect network 110 may be supported by inter-die or inter-chip communication protocols such as, but not limited to, the Intel® Ultra Path Interconnect (UPI) protocol. Data communications across the compute domain 102 and the I/O domain 104, in some examples, may be conducted via home agent 106. Also, communications between home agent 106 and memory 108 across memory channels 112 may be in accordance with one or more memory access protocols, such as described in various Joint Electronic Device Engineering Councils specification for double data rate (DDR) memory access. For example, JEDEC DDR specifications to include, but not limited to, DDR3, DDR4, DDR5, LPDDR3, LPDDR4, LPDDR5, high bandwidth memory (HBM), HBM2 or HBM3. In other examples, memory access protocols may be in accordance with other types of specifications such as the compute express link (CXL) specification.

While the system 100 is shown as having a single compute domain 102, a single input/output domain 104, a single home agent 106, and a single memory 108, alternative examples of system 100 may include multiple compute domains 102, multiple input/output domains 104, multiple home agents 106, and/or multiple memories 108. System 100 may include additional components that facilitate the operation of the system 100. Furthermore, while an example of interconnect network 110 and memory channel(s) 112 illustrate the coupling between the different components of system 100, alternative networks and/or memory channel configurations may be used to couple components of system 100.

According to some examples, compute domain 102 may include one or more core(s) 114, a compute domain shared cache hierarchy 118, and a compute domain caching agent 116. An example of a compute domain shared cache hierarchy 118 is an L3 cache. For these examples, compute domain shared cache hierarchy 118 may be shared by and accessible to core(s) 114 in the compute domain 102. Each core from among core(s) 114 includes a hardware circuit, such as a control circuit 120, to execute core operations and includes a core cache hierarchy 122. According to some examples, core cache hierarchy 122 includes L1 cache and an L2 cache. Compute domain caching agent 116 may manage operations associated with compute domain shared cache hierarchy 118. To this end, the compute domain caching agent 116 includes a hardware circuit, such as a control circuit 124, to manage operations associated with compute domain shared cache hierarchy 118. Compute domain 102 is not limited to the components shown in FIG. 1, compute domain 102 may include additional components that facilitate operation of compute domain 102.

In some examples, I/O domain 104 may include one or more I/O device(s) 126, one or more I/O agent(s) 128, an I/O domain cache hierarchy 130, and an I/O domain caching agent 132. Each I/O agent of I/O agent(s) 128 may be coupled to a respective I/O device from among I/O device(s)s 126. For these examples, I/O domain cache hierarchy 130 may be coupled to and be shared by I/O agent(s)s 128. An example of I/O domain cache hierarchy 130 is an L3 cache. Each I/O device of I/O device(s) 126 may include a hardware circuit, such as a control circuit 134, to manage I/O device operations. Each I/O agent from among I/O agent(s) 128 may include a hardware circuit, such as a control circuit 136, to manage I/O agent operations and an internal cache 138. Internal cache 138 may also be referred to as a write buffer. Examples of I/O agents include, but are not limited to, accelerator device instances such as a data streaming accelerator or a host processor with multiple I/O device(s) 126 connected downstream. I/O domain caching agent 132 includes a hardware circuit, such as a control circuit 140, to manage cache operations for I/O domain cache hierarchy 130. I/O domain 104 is not limited to the components shown in FIG. 1, I/O domain 104 may include additional components that facilitate operation of I/O domain 104.

According to some examples, home agent 106 may include, maintain, or have access to a domain mapping information (DMI) 143 maintained in a memory structure 141 located at home agent die 148. Memory structure 141 may be part of a non-volatile memory or a volatile memory located at home agent die 148 (not shown). DMI 143 may be programmed or generated by BIOS 101 responsive to initialization or startup of system 100. As described more below, system physical address spaces associated with memory (e.g., memory 108) accessed via memory channels 112 may be mapped to multiple proximity domains as indicated in DMI 143. In a generic case, a number of proximity domains will be equal to a number of L3 cache proximity domains defined in compute domain shared cache hierarchy 118. For these examples, system physical address space may be distributed across different proximity domains irrespective of an address interleaving across different memory channels included in memory channels 112. For these examples, once proximity domains are defined according to information included in DMI 143, system physical address is associated with or mapped to a respective core L3 cache proximity domain from among the number of L3 cache proximity domains defined in compute domain shared cache hierarchy 118.

In some examples, one or more physical address decoders (PAD(s)) 145 may be arranged or programmed (e.g., by BIOS 101) to facilitate look ups of L3 cache associated with proximity domains. The proximity domains mapped to system memory physical addresses as indicated by information included in DMI 143 maintained in memory structure 141. For these examples, OS 103 may decide to run application or software threads (not shown) on a core from among core(s) 114 that has been affinitized or assigned to a proximity domain (e.g., domain-0). For performance reasons, OS 103 may allocate a portion of system memory physical addresses for memory 108 to the application or software threads from system memory physical address space mapped to a same proximity domain (e.g., domain-0). Allocating system memory physical addresses to a same proximity domain may enable home agent 106 to push data generated by I/O devices(s) 126 to compute domain caching agent 116 with information to indicate what cache line of an L3 cache associated with a proximity domain is to receive the pushed data and to indicate to compute domain caching agent 116 to place an applicable cache line in compute domain shared cache hierarchy 118 in a placeholder P cache state in accordance with the MESIP protocol in order to eventually receive the pushed data. An example flow or process for this pushing of data generated or produced by an I/O device to a compute domain caching agent is described in more detail below. Home agent 106 is not limited to the components shown in FIG. 1, home agent 106 may include additional components that facilitate operation of home agent 106.

In some examples, compute domain 102 is disposed on a compute die 144 and I/O domain 104 is disposed on an I/O die 146. Also, in some examples, home agent 106 is disposed on a home agent die 148 and the memory 108 is disposed on a memory die 150. In alternative examples, home agent 106 may be disposed on one of compute die 144, I/O die 146, or memory die 150. In alternative examples, multiple compute domains 102 may be disposed on a single compute die 144 and/or multiple I/O domains 104 may be disposed on a single I/O die 146. In some examples, compute domain 102 and home agent 106 may be components of a local socket. In other examples, compute domain 102 and home agent 106 may be components of a remote socket.

According to some examples, memory die 150 may include one or more memory dies. For these examples, memory 108 may include various types of volatile and/or non-volatile memory. Volatile types of memory may include, but are not limited to, dynamic random access memory (DRAM), static random access memory (SRAM), thyristor RAM (TRAM) or zero-capacitor RAM (ZRAM). Non-volatile types of memory may include byte or block addressable types of non-volatile memory having a 3-dimensional (3-D) cross-point memory structure that includes chalcogenide phase change material (e.g., chalcogenide glass) hereinafter referred to as “3-D cross-point memory”. Non-volatile types of memory may also include other types of byte or block addressable non-volatile memory such as, but not limited to, multi-threshold level NAND flash memory, NOR flash memory, single or multi-level phase change memory (PCM), resistive memory, nanowire memory, ferroelectric transistor random access memory (FeTRAM), magnetoresistive random access memory (MRAM) that incorporates memristor technology, spin transfer torque MRAM (STT-MRAM), or a combination of any of the above.

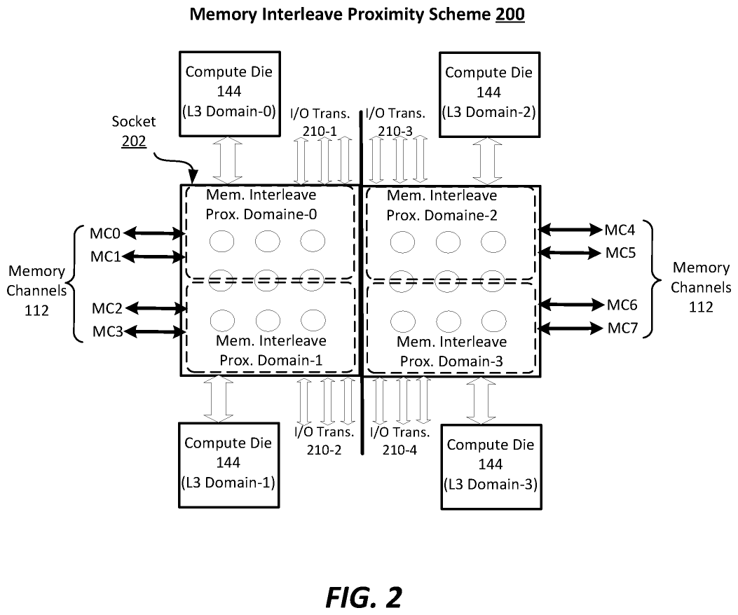

FIG. 2 illustrates an example memory interleave proximity scheme 200. In some examples, as shown in FIG. 2, four memory interleave proximity domains may be implemented on a single socket 202. For these examples, as shown in FIG. 2, the four memory interleave proximity domains include domain-0, domain-1, domain-2, and domain-3. As described more below, memory interleave proximity domain-0 to domain-3 interleave system memory physical address spaces behind MCs 0/1, 2/3, 4/5 and 6/7, respectively. MCs 0/1, 2/3, 4/5 and 6/7 are shown in FIG. 2 as being included in memory channels 112 that couples with memory 108 as shown in FIG. 1.

According to some examples, as describe further below, cores located on a compute die such as cores 144-1 to 144-4 of compute die 144 as well as L3 cache used by each respective core may be separately affinitized to a proximity domain from among proximity domains 0-3. For these examples, based on memory interleave proximity scheme 200 and based on how system physical address spaces behind MCs 0/1, 2/3, 4/5 and 6/7 are interleaved, I/O transactions 210-1 to 210-4, that may be associated with data produced by one or more I/O devices (e.g., I/O device(s) 126), are pushed to a caching agent at a compute domain (e.g., compute domain caching agent 116) for eventual placement in a cache line of an L3 cache included in an applicable compute domain cache hierarchy (e.g., compute domain shared cache hierarchy 118) based on what core is to consume the data. A home agent (e.g., home agent 106) may use domain mapping information (e.g., DMI 143) to push the data associated with I/O transactions 210-1 to 210-4 to the caching agent for eventual placement in the cache line of the L3 cache for consumption of the data by a core from among cores 114-1 to 114-4. In some examples, the domain mapping information may include information related to memory interleave proximity scheme 200 and how each memory interleave proximity domain is mapped to respective system memory physical address spaces behind MCs 0/1, 2/3, 4/5 and 6/7.

Examples for memory interleave proximity schemes are not limited to implementations that include a single socket with 4 proximity domains. Multiple sockets with more or less than 4 proximity domains are contemplated by this disclosure.

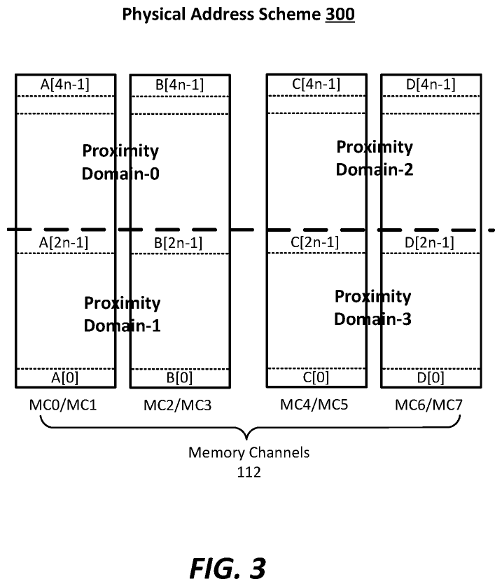

FIG. 3 illustrates an example physical address scheme 300. According to some examples, physical address scheme 300 shown in FIG. 3 shows how contiguous system memory physical addresses across different sets of memory channels of memory channels 112 may be assigned or mapped to a respective proximity domain from among proximity domains 0-3. For these examples, system memory physical address spaces accessible via MCs 0-7 are sliced horizontally to assign certain system memory physical address ranges to the 4 memory interleave proximity domains shown in FIG. 2 for memory interleave proximity scheme 200. As mentioned above, information related to the 4 memory interleave proximity domains mapped to respective system physical address spaces behind MCs 0/1, 2/3, 4/5 and 6/7 may be included in domain mapping information (e.g., DMI 143) that may be used by a home agent to push data associated with an I/O transaction to a caching agent.

In some examples, as shown in FIG. 3, system memory physical address spaces A[0] to A[2n−1] and B[0] to B[2n−1] are mapped to proximity domain 0. System memory physical address spaces A[2n] to A[4n−1] and B[2n] to B[4n−1] are mapped to proximity domain 1. System memory physical address spaces C[0] to C[2n−1] and D[0] to D[2n−1] are mapped to proximity domain 2. System memory physical address spaces C[2n] to C[4n−1] and D[2n] to D[4n−1] are mapped to proximity domain 3. Examples are not limited to slicing system memory physical address space horizontally as shown in FIG. 3, other ways to partition system memory physical address spaces behind memory channels are contemplated by this disclosure.

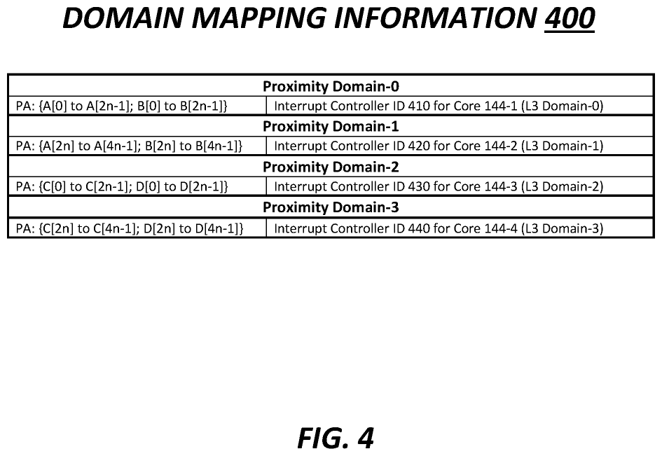

FIG. 4 illustrates example domain mapping information 400. According to some examples, domain mapping information 400 may be associated with an SRAT generated or programmed by a BIOS (e.g., BIOS 101) in accordance with the ACPI specification and includes information related to memory interleave proximity scheme 200 shown in FIG. 2 and physical address scheme 300 shown in FIG. 3. For these examples, domain mapping information 400 may be accessible by a home agent (e.g., home agent 106) to facilitate look ups of L3 cache proximity domains associated with mapped system memory addresses mapped to respective same proximity domains.

In some examples, as shown in FIG. 4, domain mapping information 400 includes information related to 4 proximity domains 0-3. Proximity domain-0 indicates that physical address (PA) A[0] to A[2n−1] and B[0] to B[2n−1] are mapped to proximity domain 0 and that a core 114-1 having an interrupt controller identifier (ID) of 410 uses an L3 cache identified as L3 domain-0. Proximity domain-1 indicates that PA A[2n] to A[4n−1] and B[2n] to B[4n−1] are mapped to proximity domain 1 and that a core 114-2 having an interrupt controller ID of 420 uses an L3 cache identified as L3 domain-1. Proximity domain-2 indicates that PA C[0] to C[2n−1] and D[0] to D[2n−1] are mapped to proximity domain 3 and that a core 114-3 having an interrupt controller ID of 430 uses an L3 cache identified as L3 domain-2. Proximity domain-3 indicates that PA C[2n] to C[4n−1] and D[2n] to D[4n−1] are mapped to proximity domain 3 and that a core 114-4 having an interrupt controller ID of 440 uses an L3 cache identified as L3 domain-0. According to some examples, an interrupt controller ID for cores 114-1 to 114-4 may include, but is not limited to, an advanced programmable interrupt controller ID (APIC ID), a streamlined APIC ID (SAPIC ID) or a generic interrupt controller ID (GIC ID).

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware examples, a logic flow may be implemented by computer executable instructions stored on at least one non-transitory computer readable medium or machine readable medium, such as an optical, magnetic or semiconductor storage. The examples are not limited in this context.

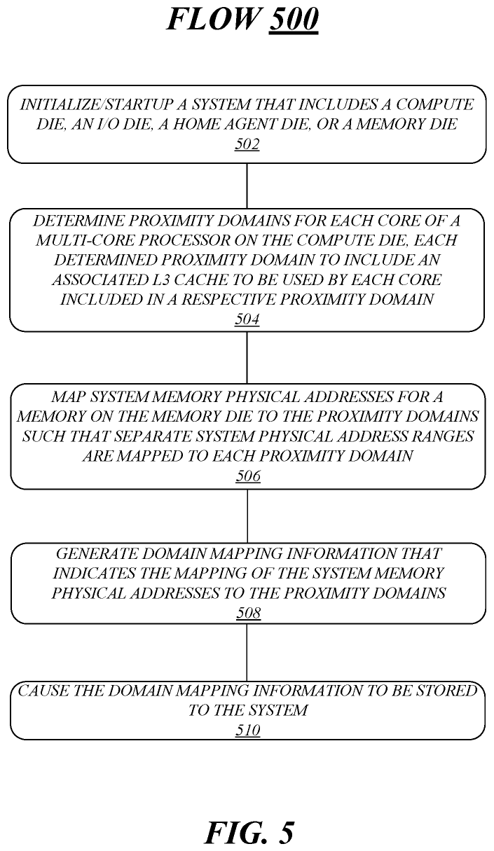

FIG. 5 illustrates an example logic flow 500. Logic flow 500 may be representative of some or all of the operations executed implemented by a BIOS to program or generate an SRAT and associated domain mapping information that includes information such as described and mentioned above for domain mapping information 400. According to some examples, components of system 100 such as BIOS 101, core(s) 114, compute domain shared cache hierarchy 118, home agent 106 or memory 108 as mentioned above or shown in FIGS. 1-4. Examples are not limited to these components. Also, for these examples, the SRAT is generated in accordance with the ACPI specification during a point of initialization of OS 103 when evaluation of objects in an ACPI Namespace is not yet possible.

In some examples, as shown in FIG. 5, logic flow 500 at block 502 may initialize/startup a system that includes a compute die, an I/O die, a home agent die, or a memory die. For these examples, the system initialized or started up is system 100 that includes compute die 144, I/O die 146, home agent die 148 and memory die 150.

According to some examples, logic flow 500 at 504 may determine proximity domains for each core of a multi-core processor on the compute die, each determined proximity domain to include an associated L3 cache to be used by each core included in a respective proximity domain. For example, BIOS 101 may refer to a processor local APIC/SAPIC affinity structure for core(s) 114 to determine what proximity domain each core from among core(s) 114 are to be associated with as well as determining what associated L3 cache included in compute domain shared cache hierarchy 118 is used by each core include in a respective proximity domain.

In some examples, logic flow 500 at block 506 may map system memory physical addresses for a memory on the memory die to the proximity domains such that separate system physical address ranges are mapped to each proximity domain. For these examples, BIOS 101 may map system memory physical addresses for memory 108 to proximity domains 0-3 as mentioned above for physical address scheme 300 shown in FIG. 3.

According to some examples, logic flow 500 at block 508 may generate domain mapping information that indicates the mapping of the system memory physical addresses to the proximity domains. For these examples, BIOS 101 may generate or program the domain mapping to include the information shown in FIG. 4 for domain mapping information 400.

In some examples, logic flow 500 at block 510 may cause the domain mapping information to be stored to the system. For these examples, BIOS 101 may cause the domain mapping information to be stored at home agent die 148 and/or make the domain mapping information accessible to home agent 106. According to some examples, home agent 106 may use the information in the domain mapping information stored at home agent die 148 or accessible to home agent 106 to push data associated with I/O transactions 210-1 to 210-4 to compute domain caching agent 116 for eventual placement in an L3 cache line for consumption of the data by a core from among cores 114-1 to 114-4.

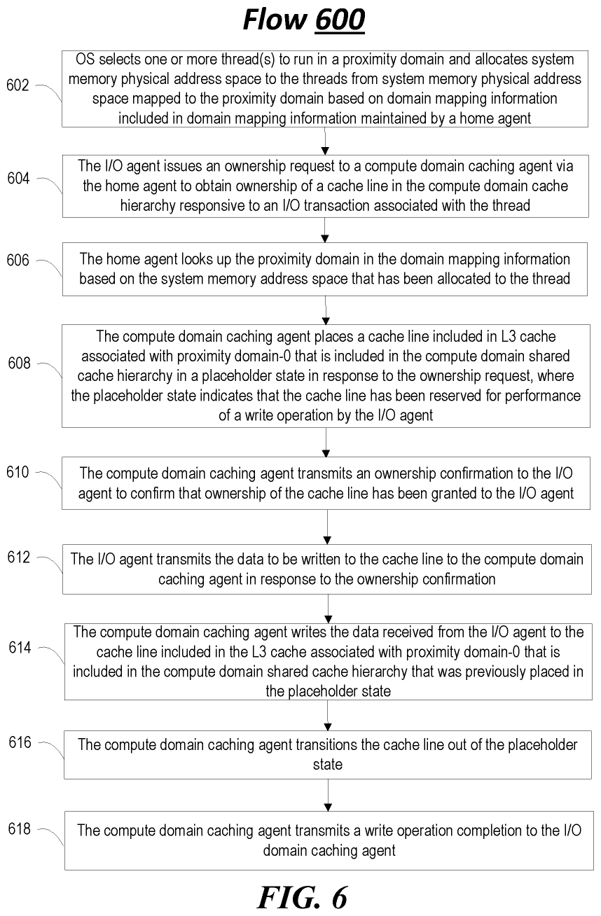

FIG. 6 illustrates an example logic flow 600. Logic flow 600 may be an example of implementing a write operation using a placeholder P state in a compute domain cache hierarchy following an OS's decision to run an application or software thread on a core associated with an L3 cache included in the compute domain cache hierarchy, the core and the L3 cache associated with a proximity domain as indicated in domain mapping information associated with an SRAT. According to some examples, logic flow 600 may be performed when an I/O agent 128 in I/O domain 104 of system 100 writes data to compute domain shared cache hierarchy 118 in compute domain 102. Logic flow 600 may be performed by components of I/O domain 104 and components of compute domain 102 in combination with additional components of system 100 such as components of home agent 106. Logic flow 600 may be performed by hardware circuitry, firmware, software, and/or combinations thereof.

According to some examples, as shown in FIG. 6, at 602, OS 103 selects one or more application thread(s) to run in a proximity domain and allocates system memory physical address space to the threads from system memory physical address space mapped to the proximity domain based on domain mapping information 400 included in DMI 143 maintained by home agent 106. For example, if domain 0 is selected, then according to domain mapping information 400, at least a portion of system memory physical address space from among physical addresses A[0] to A[2n−1]; B[0] to B[2n−1] is allocated to the application thread.

At 604, I/O agent 128 in I/O domain 104 issues an ownership request to compute domain caching agent 116 via home agent 106 to obtain ownership of a cache line in compute domain shared cache hierarchy 118 in compute domain 102 responsive to an I/O transaction associated with the application thread. According to some examples, I/O agent 128 transmits an ownership request for a cache line in an L3 cache associated with the proximity domain selected for the application thread(s) by OS 103, the L3 cache included in compute domain shared cache hierarchy 118.

At 606, home agent 106 looks up the proximity domain in domain mapping information 400 based on the system memory address space that has been allocated to the application thread. As indicated above, system memory physical address space included in physical addresses A[0] to A[2n−1]; B[0] to B[2n−1] is allocated to the application thread and according to domain mapping information 400, this system memory physical address space is associated with proximity domain-0.

At 608, compute domain caching agent 116 places a cache line included in L3 cache associated with proximity domain-0 that is included in compute domain shared cache hierarchy 118 in a placeholder P state in response to the ownership request. The placeholder P state indicates that the cache line has been reserved for performance of a write operation by I/O agent 128 by granting temporary ownership of the cache line to I/O agent 128. The placeholder P state indicates that the cache line is dirty with respect to memory. The state of the cache line is transitioned from one of the invalid I state or the modified M state to the placeholder P state.

At 610, compute domain caching agent 116 transmits an ownership confirmation to the I/O agent 128 to confirm that ownership of the cache line has been granted to I/O agent 128. According to some examples, compute domain caching agent 116 transmits the ownership confirmation to the I/O agent 128 via I/O domain caching agent 132. In other examples, compute domain caching agent 116 transmits the ownership confirmation to home agent 106 and home agent 106 transmits the ownership confirmation to I/O domain caching agent 132 for transmission to I/O agent 128. For either of these examples, the ownership is granted to I/O agent 128 without the transmission of the content of the cache line to I/O agent 128.

At 612, I/O agent 128 transmits the data to be written to the cache line in compute domain shared cache hierarchy 118 to compute domain caching agent 116 in response to the ownership confirmation. I/O agent 128 transmits the data to I/O domain caching agent 132. I/O domain caching agent 132 transmits the received data to compute domain caching agent 116. In some examples, I/O domain caching agent 132 transmits the received data to compute domain caching agent 116 via home agent 106. According to some examples, the transmitted data is I/O data produced by an I/O device from among I/O device(s) 126.

At 614, the compute domain caching agent 116 writes the data received from I/O agent 128 to the cache line included in L3 cache associated with L3 proximity domain-0 that is included in compute domain shared cache hierarchy 118 that was previously placed in the placeholder P state. In some examples, the compute domain caching agent 116 writes the received data to the cache line in the L3 cache in the compute domain shared cache hierarchy 118.

At 616, compute domain caching agent 116 transitions the cache line out of the placeholder P state. According to some examples, compute domain caching agent 116 transitions the state of the cache line included in L3 cache associated with L3 proximity domain-0 that is included in compute domain shared cache hierarchy 118 from the placeholder P state to one of the invalid I state or the modified M state.

At 618, compute domain caching agent 116 transmits a write operation completion to I/O domain caching agent 132. According to some examples, compute domain caching agent 116 transmits the write operation completion to home agent 106 and home agent 106 transmits the write operation completion to I/O domain caching agent 132. For these examples, the write operation completion indicates to I/O domain caching agent 132 that the data has been written to the cache line included in L3 cache associated with L3 proximity domain-0 that is included in compute domain shared cache hierarchy 118 and that I/O agent 128 no longer has ownership of the cache line. It is to be understood that the logic flow 600 is shown at a high level in FIG. 6 and that many variations in and alternatives of logic flow 600 are possible.

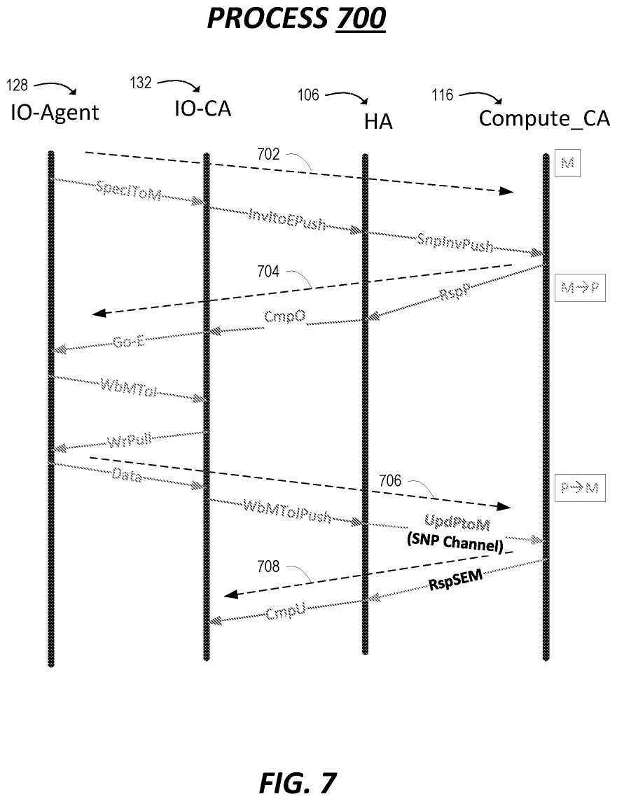

FIG. 7 illustrates an example process 700. As shown in FIG. 7, illustrates examples of transactions involved in a process of a write operation using a placeholder P in a compute domain cache hierarchy following an OS's decision to run an application or software thread on a core using an L3 cache included in the compute domain cache hierarchy. For these examples process 700 may be performed by I/O agent (IO-Agent) 128, I/O domain caching agent (IO-CA) 132, home agent (HA) 106, and compute domain caching agent (compute_CA) 116. The transactions may be performed by hardware circuitry, firmware, software, and/or combinations thereof.

According to some examples, I/O agent 128 issues an ownership request 702 to the compute domain caching agent 116 via I/O domain caching agent 132 and home agent 106 to obtain ownership of a cache line that I/O agent 128 would like to write to in the compute domain cache hierarchy responsive to an I/O transaction associated with an application or software thread being executed by a core from among core(s) 114. For example, I/O agent 128 requests ownership of a cache line in an L3 cache associated with the proximity domain selected for the thread(s) by OS 103, the L3 cache include in compute domain shared cache hierarchy 118.

In some examples, ownership request 702 includes three transactions, transmission of a protocol message SpeclToM, transmission of a protocol message InvltoEPush and transmission of a snoop message SnpinvPush. For these examples, I/O agent 128 transmits the protocol message SpeclToM to I/O domain caching agent 132. The protocol message SpeclToM is a protocol Opcode where I/O agent 128 issues a request to I/O domain caching agent 132 to own a cache line in an L3 cache associated with the proximity domain selected for the thread(s) by OS 103, the L3 cache include in compute domain shared cache hierarchy 118. In examples where the request is from a PCIe I/O device, the request is speculative since the PCIe I/O device may or may not write to the cache line. In other examples, an accelerator device issues a non-speculative request since once an accelerator device requests ownership of a cache line, the accelerator device is expected to write data to that cache line.

According to some examples, responsive to the protocol message SpeclToM, I/O domain caching agent 132 transmits the protocol message InvltoEPush to home agent 106. Responsive to the protocol message InvltoEPush, home agent 106 transmits the snoop message SnpinvPush to the compute domain caching agent 116 via a snoop channel. The snoop message SnpinvPush seeks to invalidate the cache line and transition this cache line to the placeholder P state.

In some examples, responsive to the snoop message SnpinvPush, compute domain caching agent 116 transitions the state of the cache line from the modified M state to the placeholder P state. The placeholder P state indicates that the cache line has been reserved for performance of a write operation by I/O agent 128. Placing the cache line in the placeholder P state grants I/O agent 128 temporary ownership of the cache line. When the cache line is placed in the placeholder P state, the cache line is in a dirty state with respect to a memory.

According to some examples, compute domain caching agent 116 transmits an ownership confirmation 704 to I/O agent 128 via home agent 106 and I/O domain caching agent 132 confirming that ownership of the cache line has been granted to the I/O agent 128. The ownership confirmation 704 includes three transactions. In the first transaction, compute domain caching agent 116 issues an ownership confirmation RspP to home agent 106 via the snoop channel confirming that I/O agent 128 has been granted ownership of the cache line and that the cache line has been placed in the placeholder P state. The ownership confirmation RspP indicates a successful response to the snoop message SnpinvPush.

In some examples, responsive to the receipt of the ownership confirmation RspP, home agent 106 engages in the second transaction where home agent 106 issues an ownership confirmation CmpO to I/O domain caching agent 132. Home agent 106 sends the CmpO message to I/O domain caching agent 132 to acknowledge that I/O agent 128 has been granted ownership of the cache line. Upon receipt of the CmpO message, I/O domain caching agent 132 engages in the third transaction by transmitting a Go-E message to I/O agent 128 indicating that ownership of the cache line has been granted to I/O agent 128.

According to some examples, upon receipt of the Go-E message, I/O agent 128 transmits the data 706 to be written to the cache line in the placeholder P state to compute domain caching agent 116 via I/O domain caching agent 132 and home agent 106. The data transmission 706, for example, may be associated with one or more I/O transactions that generated data to be consumed by a core from among core(s) 114.

In some examples, the transmission of the data from I/O agent 128 to I/O domain caching agent 132 involves a series of transactions. For these examples, the series of transactions includes the transmission of a writeback message WbMTol from I/O agent 128 to I/O domain caching agent 132, transmission of a WrPull request from I/O domain caching agent 132 to I/O agent 128, and the transmission of data from I/O agent 128 to I/O domain caching agent 132.

According to some examples, responsive to the receipt of data from I/O agent 128, I/O domain caching agent 132 engages in a transaction WbMTolPush where I/O domain caching agent 132 transmits the data to home agent 106. For these examples, home agent 106 transmits the data received from I/O domain caching agent 132 to compute domain caching agent 116 via the snoop channel using a protocol message UpdPtoM. The protocol message UpdPtoM indicates that the transaction uses the UPI protocol, that the transaction will involve the writing of modified data received from I/O agent 128 to the cache line in the placeholder P state, and that the cache line will be transitioned from the placeholder P state to the modified M state following the completion of the write operation.

In some examples, once I/O agent 128 has the ownership of the cache line, I/O agent 128 may potentially write the cache line in the write buffers. The dirty cache line inside I/O agent 128 is written back to I/O domain caching agent 132 and then to home agent 106. A lookup at the snoop filter at home agent 106 indicates that the cache line is currently held in the placeholder P state. A snoop with data is issued from home agent 106 to compute domain caching agent 116 to update the cache line included in L3 cache associated with proximity domain-0 that is included in compute domain shared cache hierarchy 118 with the new data. As a result, the cache line is pushed into the L3 cache associated with proximity domain-0 that is included in compute domain shared cache hierarchy 118. In alternative examples, the data may be pushed into the L3 cache associated with proximity domain-0 that is included in compute domain shared cache hierarchy 118 in the request channel.

According to some examples, upon receipt of the protocol message UpdPtoM, compute domain caching agent 116 writes the data to the cache line and transitions the state of the cache line from the placeholder P state to the modified M state.

In some examples, compute domain caching agent 116 transmits a write operation completion 708 to I/O domain caching agent 132 via home agent 106. For these examples, the write operation completion 708 includes two transactions. The first transaction involves compute domain caching agent 116 transmitting a completion response RspSEM to home agent 106 via the snoop channel. The second transaction involves home agent 106 responsively transmitting a final handshake completion CmpU to I/O domain caching agent 132. It is to be understood that the transactions illustrated in FIG. 7 are shown at a high level and that many variations in and alternatives of the transactions are possible.

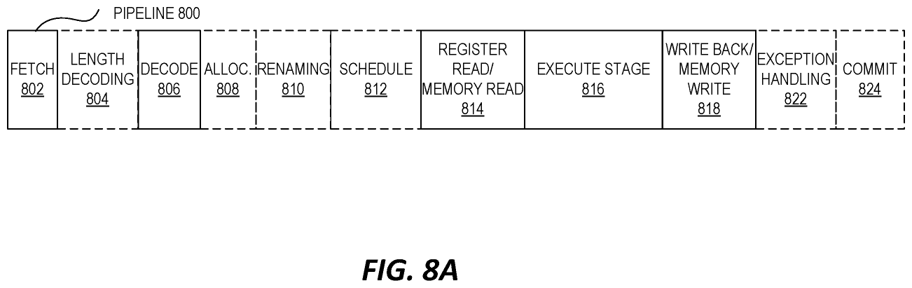

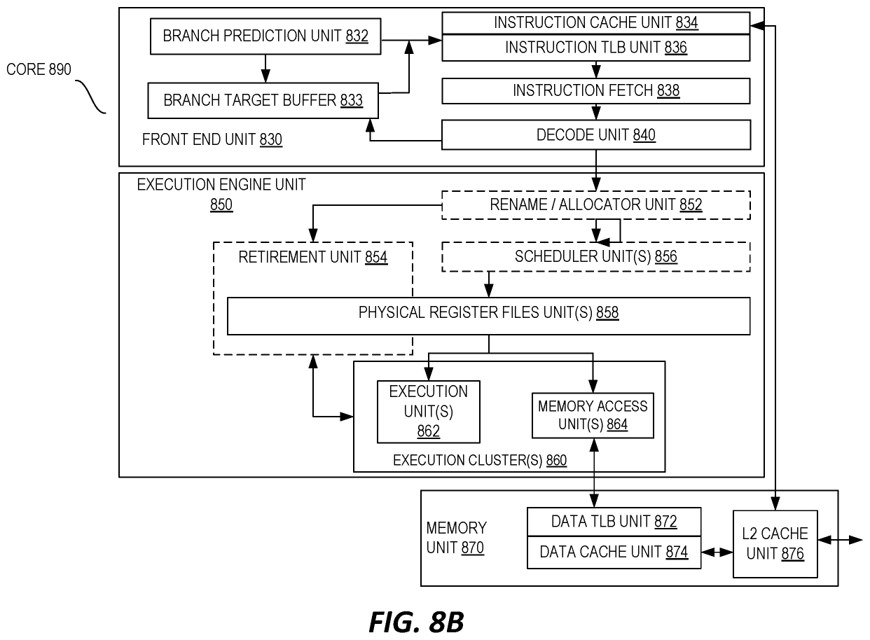

Understand that examples may be used in connection with many different processor architectures. FIG. 8A is a block diagram illustrating both an example in-order pipeline and an example register renaming, out-of-order issue/execution pipeline according to various examples. FIG. 8B is a block diagram illustrating both an example of an in-order architecture core and an example register renaming, out-of-order issue/execution architecture core to be included in a processor according to various examples. In various examples, the described architecture may be used to implement a write operation performed by an I/O agent in an I/O domain at a compute domain shared cache hierarchy. The solid lined boxes in FIGS. 8A and 8B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8A, a processor pipeline 800 includes a fetch stage 802, a length decode stage 804, a decode stage 806, an allocation stage 808, a renaming stage 810, a scheduling (also known as a dispatch or issue) stage 812, a register read/memory read stage 814, an execute stage 816, a write back/memory write stage 818, an exception handling stage 822, and a commit stage 824. Note that as described herein, in a given example a core may include multiple processing pipelines such as pipeline 800.

FIG. 8B shows processor core 890 including a front end unit 830 coupled to an execution engine unit 850, and both are coupled to a memory unit 870. The core 890 may be a reduced instruction set computing (RISC) core, a complex instruction set computing (CISC) core, a very long instruction word (VLIW) core, or a hybrid or alternative core type. As yet another option, the core 890 may be a special-purpose core, such as, for example, a network or communication core, compression engine, coprocessor core, general purpose computing graphics processing unit (GPGPU) core, graphics core, or the like.

The front end unit 830 includes a branch prediction unit 832 coupled to an instruction cache unit 834, which is coupled to an instruction translation lookaside buffer (TLB) 836, which is coupled to an instruction fetch 838, which is coupled to a decode unit 840. The decode unit 840 (or decoder) may decode instructions, and generate as an output one or more micro-operations, micro-code entry points, microinstructions, other instructions, or other control signals, which are decoded from, or which otherwise reflect, or are derived from, the original instructions. The decode unit 840 may be implemented using various different mechanisms. Examples of suitable mechanisms include, but are not limited to, look-up tables, hardware implementations, programmable logic arrays (PLAs), microcode read only memories (ROMs), etc. In some examples, the core 890 includes a microcode ROM or other medium that stores microcode for certain macroinstructions (e.g., in decode unit 840 or otherwise within the front end unit 830). The decode unit 840 is coupled to a rename/allocator unit 852 in the execution engine unit 850.

As further shown in the front end unit 830, the branch prediction unit 832 provides prediction information to a branch target buffer 833.

The execution engine unit 850 includes the rename/allocator unit 852 coupled to a retirement unit 854 and a set of one or more scheduler unit(s) 856. The scheduler unit(s) 856 represents any number of different schedulers, including reservations stations, central instruction window, etc. The scheduler unit(s) 856 is coupled to the physical register file(s) unit(s) 858. Each of the physical register file(s) units 858 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one example, the physical register file(s) unit 858 includes a vector registers unit, a write mask registers unit, and a scalar registers unit. These register units may provide architectural vector registers, vector mask registers, and general purpose registers. The physical register file(s) unit(s) 858 is overlapped by the retirement unit 854 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 854 and the physical register file(s) unit(s) 858 are coupled to the execution cluster(s) 860. The execution cluster(s) 860 includes a set of one or more execution units 862 and a set of one or more memory access units 864. The execution units 862 may perform various operations (e.g., shifts, addition, subtraction, multiplication) and on various types of data (e.g., scalar floating point, packed integer, packed floating point, vector integer, vector floating point). While some examples may include a number of execution units dedicated to specific functions or sets of functions, other examples may include only one execution unit or multiple execution units that all perform all functions. The scheduler unit(s) 856, physical register file(s) unit(s) 858, and execution cluster(s) 860 are shown as being possibly plural because certain examples create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain examples are implemented in which only the execution cluster of this pipeline has the memory access unit(s) 864). It should also be understood that where separate pipelines are used, one or more of these pipelines may be out-of-order issue/execution and the rest in-order.

The set of memory access units 864 is coupled to the memory unit 870, which includes a data TLB unit 872 coupled to a data cache unit 874 coupled to a level 2 (L2) cache unit 876. In one example, the memory access units 864 may include a load unit, a store address unit, and a store data unit, each of which is coupled to the data TLB unit 872 in the memory unit 870. The instruction cache unit 834 is further coupled to a level 2 (L2) cache unit 876 in the memory unit 870. The L2 cache unit 876 is coupled to one or more other levels of cache and eventually to a main memory.

By way of example, the example register renaming, out-of-order issue/execution core architecture may implement the pipeline 800 as follows: 1) the instruction fetch 838 performs the fetch and length decoding stages 802 and 804; 2) the decode unit 840 performs the decode stage 806; 3) the rename/allocator unit 852 performs the allocation stage 808 and renaming stage 810; 4) the scheduler unit(s) 856 performs the schedule stage 812; 5) the physical register file(s) unit(s) 858 and the memory unit 870 perform the register read/memory read stage 814; the execution cluster 860 perform the execute stage 816; 6) the memory unit 870 and the physical register file(s) unit(s) 858 perform the write back/memory write stage 818; 7) various units may be involved in the exception handling stage 822; and 8) the retirement unit 854 and the physical register file(s) unit(s) 858 perform the commit stage 824.

The core 890 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In some examples, the core 890 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated example of the processor also includes separate instruction and data cache units 834/874 and a shared L2 cache unit 876, alternative examples may have a single internal cache for both instructions and data, such as, for example, a level 1 (L1) internal cache, or multiple levels of internal cache. According to some examples, the system may include a combination of an internal cache and an external cache that is external to the core and/or the processor. Alternatively, all of the cache may be external to the core and/or the processor. Note that an example of the execution engine unit 850 described above may place a cache line in the shared L2 cache unit 876 or the L1 internal cache in a placeholder state in response to a request for ownership of the cache line from an I/O agent in an I/O domain thereby reserving the cache line for the performance of a write operation by the I/O agent using examples herein.

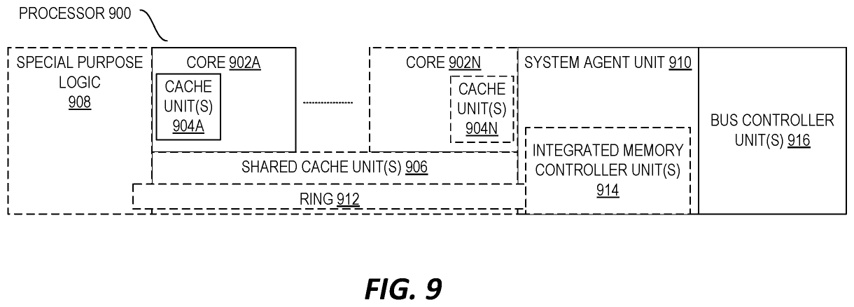

FIG. 9 is a block diagram of a processor 900 that may have more than one core, may have an integrated memory controller, and may have integrated graphics according to various examples. The solid lined boxes in FIG. 9 illustrate a processor 900 with a single core 902A, a system agent 910, a set of one or more bus controller units 916, while the optional addition of the dashed lined boxes illustrates an alternative processor 900 with multiple cores 902A-N, a set of one or more integrated memory controller unit(s) in the system agent unit 910, and a special purpose logic 908, which may perform one or more specific functions.

Thus, different implementations of the processor 900 may include: 1) a CPU with a special purpose logic being integrated graphics and/or scientific (throughput) logic (which may include one or more cores), and the cores 902A-N being one or more general purpose cores (e.g., general purpose in-order cores, general purpose out-of-order cores, a combination of the two); 2) a coprocessor with the cores 902A-N being a large number of special purpose cores intended primarily for graphics and/or scientific (throughput); and 3) a coprocessor with the cores 902A-N being a large number of general purpose in-order cores. Thus, the processor 900 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 900 may be a part of and/or may be implemented on one or more substrates using any of a number of process technologies, such as, for example, BiCMOS, CMOS, or NMOS.

The memory hierarchy includes one or more levels of cache units 904A-N within the cores, a set or one or more shared cache units 906, and external memory (not shown) coupled to the set of integrated memory controller units 914. The set of shared cache units 906 may include one or more mid-level caches, such as L2, L3, L4, or other levels of cache, a last level cache (LLC), and/or combinations thereof. While in one example a ring based interconnect unit 912 interconnects the special purpose 908, the set of shared cache units 906, and the system agent unit 910/integrated memory controller unit(s) 914, alternative examples may use any number of well-known techniques for interconnecting such units.

The system agent unit 910 includes those components coordinating and operating cores 902A-N. The system agent unit 910 may include for example a power control unit (PCU) and a display unit. The PCU may be or include logic and components needed for regulating the power state of the cores 902A-N and the special purpose logic 908. The display unit is for driving one or more externally connected displays.

The cores 902A-N may be homogenous or heterogeneous in terms of architecture instruction set; that is, two or more of the cores 902A-N may be capable of execution of the same instruction set, while others may be capable of executing only a subset of that instruction set or a different instruction set. In some examples, a cache line in one of the shared cache units 906 or one of the core cache units 904A-904N may be placed in a placeholder state in response to a cache line ownership request received from an I/O agent in an I/O domain thereby reserving the cache line for the performance of a write operation by the I/O agent as described herein.

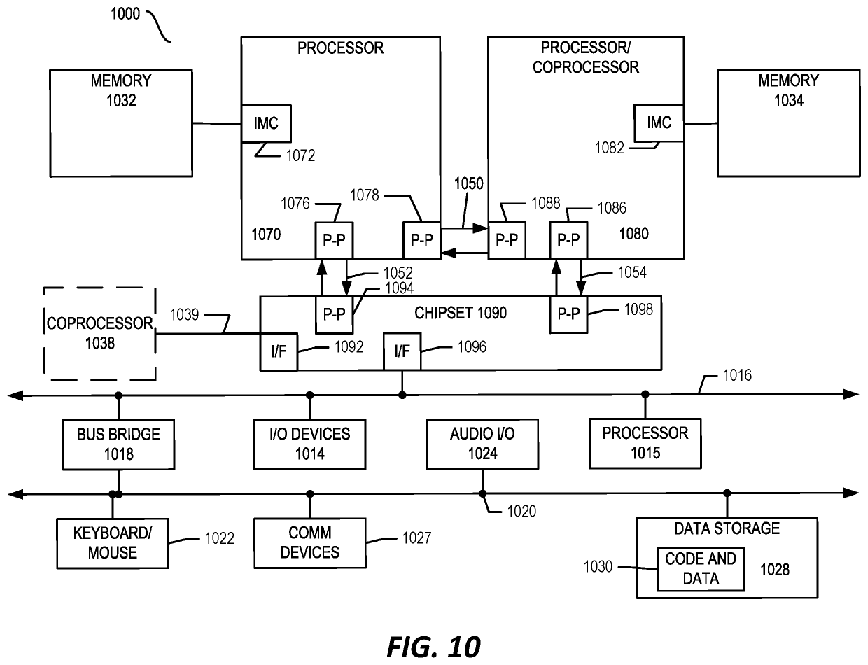

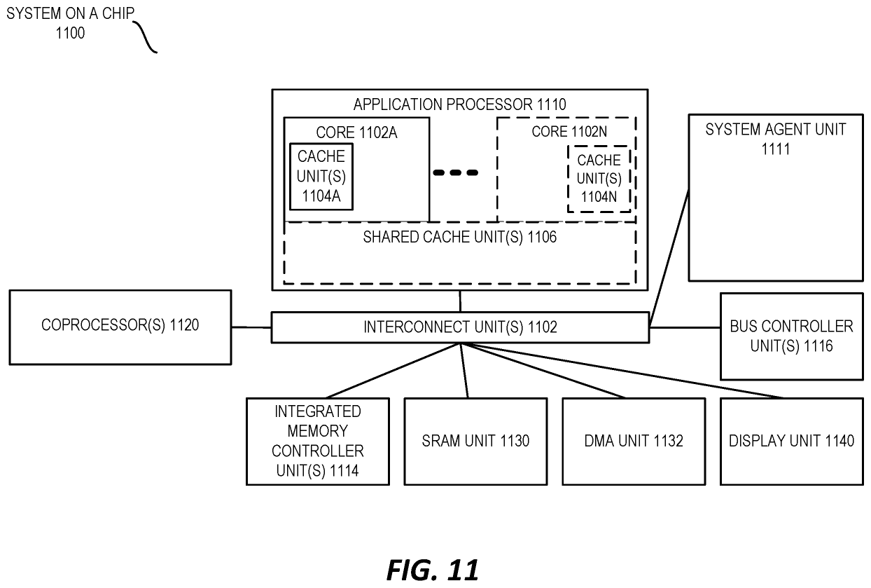

FIGS. 10-11 are block diagrams of example computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, handheld devices, and various other electronic devices, are also suitable. In general, a large variety of systems or electronic devices capable of incorporating a processor and/or other execution logic as disclosed herein are generally suitable.

Referring now to FIG. 10, shown is a block diagram of a first more specific example system 1000. As shown in FIG. 10, multiprocessor system 1000 is a point-to-point interconnect system, and includes a first processor 1070 and a second processor 1080 coupled via a point-to-point interconnect 1050. Each of processors 1070 and 1080 may be some version of the processor 1000.

Processors 1070 and 1080 are shown including integrated memory controller (IMC) units 1072 and 1082, respectively. Processor 1070 also includes, as part of its bus controller units, point-to-point (P-P) interfaces 1076 and 1078; similarly, second processor 1080 includes P-P interfaces 1086 and 1088. Processors 1070, 1080 may exchange information via a point-to-point (P-P) interface 1050 using P-P interface circuits 1078, 1088. As shown in FIG. 10, integrated memory controllers (IMCs) 1072 and 1082 couple the processors to respective memories, namely a memory 1032 and a memory 1034, which may be portions of main memory locally attached to the respective processors.

Processors 1070, 1080 may each exchange information with a chipset 1090 via individual P-P interfaces 1052, 1054 using point to point interface circuits 1076, 1094, 1086, 1098. Chipset 1090 may optionally exchange information with the coprocessor 1038 via a high-performance interface 1039. According to some examples, the coprocessor 1038 is a special-purpose processor, such as, for example, a high-throughput MIC processor, a network or communication processor, compression engine, graphics processor, GPGPU, embedded processor, or the like.

A shared cache (not shown) may be included in either processor or outside of both processors yet connected with the processors via P-P interconnect, such that either or both processors' local cache information may be stored in the shared cache if a processor is placed into a low power mode. In some examples, a cache line in the shared cache or the local cache may be placed in a placeholder state in response to an ownership request from an I/O agent in an I/O domain thereby reserving the cache line for the performance of a write operation by the I/O agent.

Chipset 1090 may be coupled to a first bus 1016 via an interface 1096. In some examples, first bus 1016 may be a Peripheral Component Interconnect (PCI) bus, or a bus such as a PCI Express bus or another third generation I/O interconnect bus, although the scope is not so limited.

As shown in FIG. 10, various I/O devices 1014 may be coupled to first bus 1016, along with a bus bridge 1018 which couples first bus 1016 to a second bus 1020. According to some examples, one or more additional processor(s) 1015, such as coprocessors, high-throughput MIC processors, GPGPU's, accelerators (such as, e.g., graphics accelerators or digital signal processing (DSP) units), field programmable gate arrays, or any other processor, are coupled to first bus 1016. In one example, second bus 1020 may be a low pin count (LPC) bus. Various devices may be coupled to a second bus 1020 including, for example, a keyboard and/or mouse 1022, communication devices 1027 and a storage unit 1028 such as a disk drive or other mass storage device which may include instructions/code and data 1030, in one example. Further, an audio I/O 1024 may be coupled to the second bus 1020. Note that other architectures are possible. For example, instead of the point-to-point architecture of FIG. 10, a system may implement a multi-drop bus or other such architecture.

Referring now to FIG. 11, shown is a block diagram of a SoC 1100 in accordance with an example. Dashed lined boxes are optional features on more advanced SoCs. In FIG. 11, an interconnect unit(s) 1102 is coupled to: an application processor 1110 which includes a set of one or more cores 1102A-N (including constituent cache units 1104A-N); shared cache unit(s) 1106; a system agent unit 1112; a bus controller unit(s) 1116; an integrated memory controller unit(s) 1114; a set or one or more coprocessors 1120 which may include integrated graphics logic, an image processor, an audio processor, and a video processor; a static random access memory (SRAM) unit 1130; a direct memory access (DMA) unit 1132; and a display unit 1140 for coupling to one or more external displays. In one example, the coprocessor(s) 1120 include a special-purpose processor, such as, for example, a network or communication processor, compression engine, GPGPU, a high-throughput MIC processor, embedded processor, or the like. In various examples, a cache line in a constituent cache unit 1104A-N or in a shared cache unit 1106 may be placed in a placeholder state in response to an ownership request for a cache line from an I/O agent in an I/O domain thereby reserving the cache line for the performance of a write operation by the I/O agent.

Examples of the mechanisms disclosed herein may be implemented in hardware, software, firmware, or a combination of such implementation approaches. Various examples may be implemented as computer programs or program code executing on programmable systems comprising at least one processor, a storage system (including volatile and non-volatile memory and/or storage elements), at least one input device, and at least one output device.

Program code, such as code 1130 illustrated in FIG. 11, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one example may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, various examples also include non-transitory, tangible machine-readable media containing instructions or containing design data, such as Hardware Description Language (HDL), which defines structures, circuits, apparatuses, processors and/or system features described herein. Such examples may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

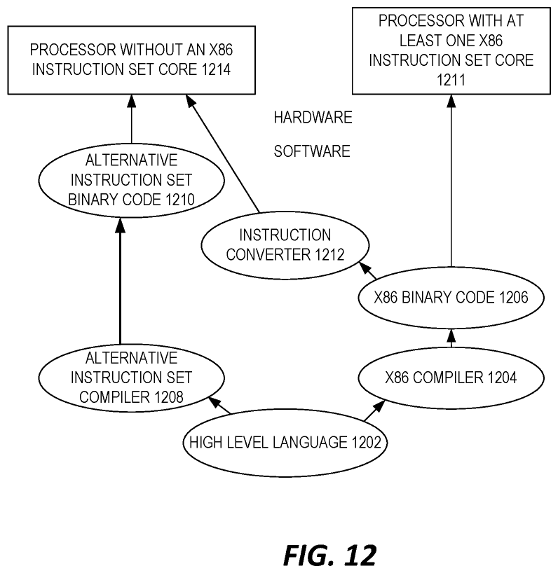

FIG. 12 is a block diagram contrasting the use of a software instruction converter to convert binary instructions in a source instruction set to binary instructions in a target instruction set according to various examples. In the illustrated example, the instruction converter is a software instruction converter, although alternatively the instruction converter may be implemented in software, firmware, hardware, or various combinations thereof. FIG. 12 shows a program in a high level language 1202 may be compiled using an x86 compiler 1204 to generate x86 binary code 1206 that may be natively executed by a processor with at least one x86 instruction set core 1216. The processor with at least one x86 instruction set core 1216 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1204 represents a compiler that is operable to generate x86 binary code 1206 (e.g., object code) that can, with or without additional linkage processing, be executed on the processor with at least one x186 instruction set core 1216. Similarly, FIG. 12 shows the program in the high level language 1202 may be compiled using an alternative instruction set compiler 1208 to generate alternative instruction set binary code 1210 that may be natively executed by a processor without at least one x86 instruction set core 1214 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1212 is used to convert the x86 binary code 1206 into code that may be natively executed by the processor without an x86 instruction set core 1214. This converted code is not likely to be the same as the alternative instruction set binary code 1210 because an instruction converter capable of this is difficult to make; however, the converted code will accomplish the general operation and be made up of instructions from the alternative instruction set. Thus, the instruction converter 1212 represents software, firmware, hardware, or a combination thereof that, through emulation, simulation, or any other process, allows a processor or other electronic device that does not have an x86 instruction set processor or core to execute the x86 binary code 1206

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The following examples pertain to additional examples of technologies disclosed herein.

Example 1. An example at least one machine readable medium may include a plurality of instructions that in response to being executed by a system, may cause the system to determine proximity domains for each core of a multi-core processor located on a compute die, each proximity domain to include an associated L3 cache for use by each core included in a respective proximity domain, the associated L3 cache located on the compute die. The instructions may also cause the system to map system memory physical addresses for a memory located on a memory die to the proximity domains such that separate system memory physical address ranges are mapped to each proximity domain. The instructions may also cause the system to generate domain mapping information that indicates the mapping of the separate system memory physical address ranges to the proximity domains. The instructions may also cause the system to cause the domain mapping information to be stored to the system.

Example 2. The at least one machine readable medium of example 1, the instructions to cause the domain mapping information to be stored to the system may include the domain mapping information to be stored to a home agent die coupled with the compute die and the memory die.

Example 3. The at least one machine readable medium of example 2, a home agent may be located on the home agent die to use the domain mapping information to route data produced by an I/O device located on an I/O die to an L3 cache used by a core of the multi-core processor based on the mapping of the separate system memory physical address ranges to the proximity domains indicated in the domain mapping information. For these examples, the I/O die is coupled with the home agent die.

Example 4. The at least one machine readable medium of example 3, the instructions to cause the system to map system memory physical addresses to the proximity domains may include the instructions to cause the system to map contiguous system memory physical addresses across different sets of memory channels to respective proximity domains. The different sets of memory channels may couple the home agent die of the system with the memory die.

Example 5. The at least one machine readable medium of example 4, the instructions may cause the system to map contiguous system memory physical addresses across four different sets of memory channels to respective four different proximity domains.

Example 6. An example method may include determining, responsive to initialization of a system that includes a compute die and a memory die, proximity domains for each core of a multi-core processor located on the compute die. Each proximity domain may include an associated L3 cache for use by each core included in a respective proximity domain. For this example, the associated L3 cache is located on the compute die. The method may also include mapping system memory physical addresses for a memory located on the memory die to the proximity domains such that separate system memory physical address ranges are mapped to each proximity domain. The method may also include generating domain mapping information that indicates the mapping of the separate system memory physical address ranges to the proximity domains. The method may also include causing the domain mapping information to be stored to the system.

Example 7. The method of example 6, causing the domain mapping information to be stored to the system may include causing the domain mapping information to be stored to a home agent die coupled with the compute die and the memory die.

Example 8. The method of example 7, a home agent located on the home agent die may use the domain mapping information to route data produced by an I/O device located on an I/O die to an L3 cache used by a core of the multi-core processor based on the mapping of the separate system memory physical address ranges to the proximity domains indicated in the domain mapping information. For this example, the I/O die is coupled with the home agent die.

Example 9. The method of example 8, mapping system memory physical addresses to the proximity domains may include mapping contiguous system memory physical addresses across different sets of memory channels to respective proximity domains. For this example, the different sets of memory channels are to couple the home agent die with the memory die.

Example 10. The method of example 9 may also include mapping contiguous system memory physical addresses across four different sets of memory channels to respective four different proximity domains.

Example 11. An example at least one machine readable medium may include a plurality of instructions that in response to being executed by a system may cause the system to carry out a method according to any one of examples 6 to 11.

Example 12. An example apparatus may include means for performing the methods of any one of examples 6 to 11.

Example 13. An example apparatus may include a memory structure located at a first die, the memory structure to maintain a domain mapping information. The apparatus may also include circuitry located at the first die. The circuitry may receive a cache line ownership request from an I/O device. The cache line ownership request may be for ownership of a cache line of an L3 cache used by a core of a multi-core processor. The L3 cache and the core may be located on a second die. For this example, the cache line request is to place data in the L3 cache for consumption by the core while executing an application thread, the application thread allocated a portion of system memory physical addresses for a memory located on a third die. The circuitry may also determine a proximity domain for the L3 cache based on information included in the domain mapping information that indicates the portion of system memory physical addresses allocated to the application thread is mapped to the proximity domain. The circuitry may also cause the cache line of the L3 cache to be placed in a placeholder state, the placeholder state to indicate that the cache line of the L3 cache is reserved for performance of a write operation by the I/O device to the cache line of the L3 cache.

Example 14. The apparatus of example 13, the circuitry at the first die is a home agent.

Example 15. The apparatus of example 13, the I/O device is an accelerator device.

Example 16. The apparatus of example 13, the portion of system memory physical addresses allocated to the application thread may mapped to the proximity domain based on a memory interleave proximity scheme that maps contiguous system memory physical addresses across different sets of memory channels to respective proximity domains, the different sets of memory channels to couple the circuitry with the memory located on the second die.

Example 17. The apparatus of example 16, the memory interleave proximity scheme is to map contiguous system memory physical addresses across four different sets of memory channels to respective four different proximity domains. For this example, the portion of system memory physical address allocated to the application thread is included in a range of system memory physical addresses across a first set of memory channels from among the four different sets of memory channels. The first set of memory channels is mapped to a first proximity domain from among the respective four different proximity domains.

Example 18. An example method may include receiving, at a home agent located on a first die, a cache line ownership request from an I/O agent. The cache line ownership request is for ownership of a cache line of an L3 cache used by a core of a multi-core processor. The L3 cache and the core are located on a second die. For this example, the cache line request is to place data in the L3 cache for consumption by the core while executing an application thread. The application thread is allocated a portion of system memory physical addresses for a memory located on a third die. The method may also include determining a proximity domain for the L3 cache based on information included in domain mapping information that indicates the portion of system memory physical addresses allocated to the application thread is mapped to the proximity domain. The method may also include causing the cache line of the L3 cache to be placed in a placeholder state, the placeholder state to indicate that the cache line of the L3 cache is reserved for performance of a write operation by the I/O agent to the cache line of the L3 cache.

Example 19. The method of example 18, the I/O agent is associated with an I/O device located at a fourth die.

Example 20. The method of example 19, the I/O device is an accelerator device.

Example 21. The method of example 18, the portion of system memory physical addresses allocated to the application thread is mapped to the proximity domain based on a memory interleave proximity scheme that maps contiguous system memory physical addresses across different sets of memory channels to respective proximity domains. The different sets of memory channels are to couple the home agent with the memory located on the second die.

Example 22. The method of example 21, the memory interleave proximity scheme is to map contiguous system memory physical addresses across four different sets of memory channels to respective four different proximity domains. For this example, the portion of system memory physical address allocated to the application thread is included in a range of system memory physical addresses across a first set of memory channels from among the four different sets of memory channels. The first set of memory channels mapped is to a first proximity domain from among the respective four different proximity domains.

Example 23. An example at least one machine readable medium may include a plurality of instructions that in response to being executed by a system may cause the system to carry out a method according to any one of examples 18 to 22.

Example 24. An example apparatus may include means for performing the methods of any one of examples 18 to 22.

Example 25. An example at least one machine readable medium may include a plurality of instructions that in response to being executed by a system, may cause the system to receive, at a home agent located on a first die, a cache line ownership request from an I/O agent. The cache line ownership request is for ownership of a cache line of an L3 cache used by a core of a multi-core processor. The L3 cache and the core are located on a second die. For this example, the cache line request is to place data in the L3 cache for consumption by the core while executing an application thread. The application thread is allocated a portion of system memory physical addresses for a memory located on a third die. The instructions may also cause the system to determine a proximity domain for the L3 cache based on information included in domain mapping information that indicates the portion of system memory physical addresses allocated to the application thread is mapped to the proximity domain. The instructions may also cause the system to cause the cache line of the L3 cache to be placed in a placeholder state. The placeholder state is to indicate that the cache line of the L3 cache is reserved for performance of a write operation by the I/O agent to the cache line of the L3 cache.

Example 26. The at least one machine readable medium of example 25, the I/O agent is associated with an I/O device located at a fourth die.

Example 27. The at least one machine readable medium of example 26, the I/O device is an accelerator device.

Example 28. The at least one machine readable medium of example 25, the portion of system memory physical addresses allocated to the application thread is mapped to the proximity domain based on a memory interleave proximity scheme that maps contiguous system memory physical addresses across different sets of memory channels to respective proximity domains. The different sets of memory channels are to couple the home agent with the memory located on the second die.

Example 29. The at least one machine readable medium of example 28, the memory interleave proximity scheme to map contiguous system memory physical addresses across four different sets of memory channels to respective four different proximity domains. For this example, the portion of system memory physical address allocated to the application thread is included in a range of system memory physical addresses across a first set of memory channels from among the four different sets of memory channels. The first set of memory channels mapped is to a first proximity domain from among the respective four different proximity domains.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. At least one machine readable medium comprising a plurality of instructions that in response to being executed by a system, cause the system to:
determine proximity domains for each core of a multi-core processor located on a compute die, each proximity domain to include an associated level 3 (L3) cache for use by each core included in a respective proximity domain, the associated L3 cache located on the compute die;
map system memory physical addresses for a memory located on a memory die to the proximity domains such that separate system memory physical address ranges are mapped to each proximity domain;
generate domain mapping information that indicates the mapping of the separate system memory physical address ranges to the proximity domains; and
cause the domain mapping information to be stored to the system.

2. The at least one machine readable medium of claim 1, the instructions to cause the domain mapping information to be stored to the system comprising the domain mapping information to be stored to a home agent die coupled with the compute die and the memory die.

3. The at least one machine readable medium of claim 2, comprising a home agent located on the home agent die to use the domain mapping information to route data produced by an input/output (I/O) device located on an I/O die to an L3 cache used by a core of the multi-core processor based on the mapping of the separate system memory physical address ranges to the proximity domains indicated in the domain mapping information, wherein the I/O die is coupled with the home agent die.

4. The at least one machine readable medium of claim 3, the instructions to cause the system to map system memory physical addresses to the proximity domains comprises the instructions to cause the system to map contiguous system memory physical addresses across different sets of memory channels to respective proximity domains, the different sets of memory channels to couple the home agent die of the system with the memory die.

5. The at least one machine readable medium of claim 4, comprising the instructions to cause the system to map contiguous system memory physical addresses across four different sets of memory channels to respective four different proximity domains.

6. A method comprising:
determining, responsive to initialization of a system that includes a compute die and a memory die, proximity domains for each core of a multi-core processor located on the compute die, each proximity domain to include an associated level 3 (L3) cache for use by each core included in a respective proximity domain, the associated L3 cache located on the compute die;
mapping system memory physical addresses for a memory located on the memory die to the proximity domains such that separate system memory physical address ranges are mapped to each proximity domain;
generating domain mapping information that indicates the mapping of the separate system memory physical address ranges to the proximity domains; and
causing the domain mapping information to be stored to the system.

7. The method of claim 6, causing the domain mapping information to be stored to the system comprises causing the domain mapping information to be stored to a home agent die coupled with the compute die and the memory die.

8. The method of claim 7, comprising a home agent located on the home agent die to use the domain mapping information to route data produced by an input/output (I/O) device located on an I/O die to an L3 cache used by a core of the multi-core processor based on the mapping of the separate system memory physical address ranges to the proximity domains indicated in the domain mapping information, wherein the I/O die is coupled with the home agent die.

9. The method of claim 8, mapping system memory physical addresses to the proximity domains comprises mapping contiguous system memory physical addresses across different sets of memory channels to respective proximity domains, the different sets of memory channels to couple the home agent die with the memory die.

10. The method of claim 9, comprising mapping contiguous system memory physical addresses across four different sets of memory channels to respective four different proximity domains.

11. An apparatus comprising:
a memory structure located at a first die, the memory structure to maintain a domain mapping information; and
circuitry located at the first die to:
receive a cache line ownership request from an input/output (I/O) device, the cache line ownership request for ownership of a cache line of a level 3 (L3) cache used by a core of a multi-core processor, the L3 cache and the core located on a second die, wherein the cache line request is to place data in the L3 cache for consumption by the core while executing an application thread, the application thread allocated a portion of system memory physical addresses for a memory located on a third die;
determine a proximity domain for the L3 cache based on information included in the domain mapping information that indicates the portion of system memory physical addresses allocated to the application thread is mapped to the proximity domain; and
cause the cache line of the L3 cache to be placed in a placeholder state, the placeholder state to indicate that the cache line of the L3 cache is reserved for performance of a write operation by the I/O device to the cache line of the L3 cache.

12. The apparatus of claim 11, the circuitry at the first die comprises a home agent.

13. The apparatus of claim 11, the I/O device comprises an accelerator device.

14. The apparatus of claim 11, comprising the portion of system memory physical addresses allocated to the application thread is mapped to the proximity domain based on a memory interleave proximity scheme that maps contiguous system memory physical addresses across different sets of memory channels to respective proximity domains, the different sets of memory channels to couple the circuitry with the memory located on the second die.

15. The apparatus of claim 14, comprising the memory interleave proximity scheme to map contiguous system memory physical addresses across four different sets of memory channels to respective four different proximity domains, wherein the portion of system memory physical address allocated to the application thread is included in a range of system memory physical addresses across a first set of memory channels from among the four different sets of memory channels, the first set of memory channels mapped to a first proximity domain from among the respective four different proximity domains.

16. A method comprising:
receiving, at a home agent located on a first die, a cache line ownership request from an input/output (I/O) agent, the cache line ownership request for ownership of a cache line of a level 3 (L3) cache used by a core of a multi-core processor, the L3 cache and the core located on a second die, wherein the cache line request is to place data in the L3 cache for consumption by the core while executing an application thread, the application thread allocated a portion of system memory physical addresses for a memory located on a third die;
determining a proximity domain for the L3 cache based on information included in domain mapping information that indicates the portion of system memory physical addresses allocated to the application thread is mapped to the proximity domain; and
causing the cache line of the L3 cache to be placed in a placeholder state, the placeholder state to indicate that the cache line of the L3 cache is reserved for performance of a write operation by the I/O agent to the cache line of the L3 cache.

17. The method of claim 16, comprising the I/O agent is associated with an I/O device located at a fourth die.

18. The method of claim 17, the I/O device comprises an accelerator device.

19. The method of claim 16, comprising the portion of system memory physical addresses allocated to the application thread is mapped to the proximity domain based on a memory interleave proximity scheme that maps contiguous system memory physical addresses across different sets of memory channels to respective proximity domains, the different sets of memory channels to couple the home agent with the memory located on the second die.

20. The method of claim 19, comprising the memory interleave proximity scheme to map contiguous system memory physical addresses across four different sets of memory channels to respective four different proximity domains, wherein the portion of system memory physical address allocated to the application thread is included in a range of system memory physical addresses across a first set of memory channels from among the four different sets of memory channels, the first set of memory channels mapped to a first proximity domain from among the respective four different proximity domains.

21. At least one machine readable medium comprising a plurality of instructions that in response to being executed by a system, cause the system to:
receive, at a home agent located on a first die, a cache line ownership request from an input/output (I/O) agent, the cache line ownership request for ownership of a cache line of a level 3 (L3) cache used by a core of a multi-core processor, the L3 cache and the core located on a second die, wherein the cache line request is to place data in the L3 cache for consumption by the core while executing an application thread, the application thread allocated a portion of system memory physical addresses for a memory located on a third die;
determine a proximity domain for the L3 cache based on information included in domain mapping information that indicates the portion of system memory physical addresses allocated to the application thread is mapped to the proximity domain; and
cause the cache line of the L3 cache to be placed in a placeholder state, the placeholder state to indicate that the cache line of the L3 cache is reserved for performance of a write operation by the I/O agent to the cache line of the L3 cache.

22. The at least one machine readable medium of claim 21, comprising the I/O agent is associated with an I/O device located at a fourth die.

23. The at least one machine readable medium of claim 22, the I/O device comprises an accelerator device.

24. The at least one machine readable medium of claim 21, comprising the portion of system memory physical addresses allocated to the application thread is mapped to the proximity domain based on a memory interleave proximity scheme that maps contiguous system memory physical addresses across different sets of memory channels to respective proximity domains, the different sets of memory channels to couple the home agent with the memory located on the second die.

25. The at least one machine readable medium of claim 24, comprising the memory interleave proximity scheme to map contiguous system memory physical addresses across four different sets of memory channels to respective four different proximity domains, wherein the portion of system memory physical address allocated to the application thread is included in a range of system memory physical addresses across a first set of memory channels from among the four different sets of memory channels, the first set of memory channels mapped to a first proximity domain from among the respective four different proximity domains.
